(19) United States
(12) Patent Application Publication
(10) Pub. No.: US 2011/0099498 A1
(43) Pub. Date: Apr. 28, 2011

(54) GRAPHICAL USER INTERFACE HIERARCHY GENERATION

(76) Inventors: Omer BARKOL, Haifa (IL); Ruth BERGMAN, Haifa (IL); Ayelet PNUELI, Haifa (IL); Michael POGREBISKY, Rishon Le-Zion (IL); Sagi SCHEIN, Haifa (IL)

(21) Appl. No.: 12/605,416

(22) Filed: Oct. 26, 2009

(51) Int. Cl. G06F 3/048

(52) U.S. Cl. 715/771; 715/853

(57) ABSTRACT

Systems, methods, and other embodiments associated with graphical user interface (GUI) hierarchy generation are described. One example method includes generating a graph based on an image of a GUI. Nodes in the graph may represent GUI components depicted in the image. Edges in the graph may represent relationships between the GUI components. The example method may include parsing the graph according to a formal graph grammar to produce a GUI hierarchy. The GUI hierarchy may comprise descriptions of groups of the GUI components.

### BACKGROUND

A graphical user interface (GUI) is one technology that allows a person to interact with an underlying application. However, it is sometimes beneficial to allow a process to interact with the GUI. The process may facilitate observing, manipulating, repurposing, and/or summarizing the application associated with the GUI. For example, a repurposing logic may be designed to modify a GUI of a website for mobile devices. In another example, a software testing logic may track and replay user inputs to a GUI. Logics that interact with GUIs sometimes associate a specific functionality to individual elements of a GUI. Knowing a hierarchy of a GUI (e.g., how GUI elements are related) may facilitate improved interactions between logics and the GUI. However, it can sometimes be difficult for a logic to acquire GUI hierarchy information. This is in part because collecting data describing how GUI components are related to other nearby GUI components may be challenging when relationship information is not explicitly provided by an external source.

Conventional GUI hierarchy generation techniques sometimes rely on information contained in an information source (e.g., a document object model (DOM)) provided along with GUI instructions (e.g., html). However, in some cases an object hierarchy may not exist or may not contain useful information. Furthermore, even if an external source of information does include hierarchy data, the hierarchy data may not be appropriate for some applications and/or may be difficult to interpret. For example, a FLASH® application in a webpage may contain multiple GUI elements. However, the document object module (DOM) for the website could describe the entirety of the FLASH® application as a single entity. In another example, some Web 2.0 development toolkits may not adequately describe semantic information for some run-time objects. Thus, when external information describing a GUI's hierarchy is unavailable, conventional tools that rely on hierarchy information may not function optimally.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example embodiment of a method associated with GUI hierarchy generation.

FIG. 2 illustrates example embodiments of data that are used and/or produced by example systems and methods.

FIG. 3 illustrates an example embodiment of a system associated with GUI hierarchy generation.

FIG. 4 illustrates an example embodiment of a system associated with GUI hierarchy generation.

FIG. 5 illustrates an example embodiment of a computing environment in which example systems and methods, and equivalents, may operate.

### DETAILED DESCRIPTION

Systems and methods associated with graphical user interface (GUI) hierarchy generation are described. One example method includes generating a graph based on an image of a GUI. Nodes in the graph may represent GUI components depicted in the image. A node may also be associated with a description containing contextual information about a GUI element represented by the node. Edges in the graph may represent relationships between the GUI components. An edge may also be associated with a description containing contextual information about a relationship with which the edge is associated.

For example, a first radio button in a GUI may be associated with a first node in a graph and a second radio button in the GUI may be treated as a second node in the graph. The graph may have edges connecting the first node and the second node describing relationships between the two radio buttons. In one example, a first edge may be added to the graph if the two radio buttons are vertically aligned. A second edge may be added to the graph if there are no other GUI components between the two radio buttons. If an external source of information (e.g., a document object model (DOM)) states that the two radio buttons are related, the graph may have edges connecting the first node and the second node signifying this relationship(s). A person having ordinary skill in the art will recognize other relationships that may be appropriate to record as edges in the graph.

In another embodiment, an edge between two nodes in the graph is associated with multiple relationships. For example, an edge connecting two nodes representing two radio buttons could use a single edge to describe that the two radio buttons are adjacent, are vertically aligned, are related according to an external information source, and so on.

The example method also includes parsing the graph according to a formal graph grammar to produce a GUI hierarchy. In one example, a GUI hierarchy may comprise descriptions of groups of GUI components from the image. This data may be stored in a tree data structure, where the root of the tree is associated with the image of the GUI, intermediate nodes are associated with groups of GUI components, and leaf nodes are associated with individual GUI components. Nodes and edges in the tree may be associated with descriptions that provide information about what the nodes and edges represent. By way of illustration, a leaf node associated with a radio button may be a child of a titled radio button node. The titled radio button node may be a child of a radio button set node. The radio button set node may be a child of an input form node. The input form node may be a child of a root node that is associated with a GUI containing the radio button, the radio button set, and the input form, in addition to other groups and GUI components.

A formal graph grammar may comprise rules that describe an action(s) to take upon detecting a predefined sub-graph of a graph. Thus, parsing the graph according to the formal graph grammar may involve searching the graph for a predefined sub-graph and performing a specified action(s) if the predefined sub-graph is found. Consider the example where parsing the graph generates a tree GUI hierarchy. An initial tree may comprise a set of leaves representing GUI components stemming from a root node. The initial tree may be transformed into a tree with a set of intermediary nodes that describe how groups of leaves are related. While an example using a tree data structure is provided, a person having ordinary skill in the art will recognize that there may be other ways to structure a GUI hierarchy.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

DOM: document object model.

GUI: graphical user interface.

PCIE: peripheral component interconnect express.

RAM: random access memory.

ROM: read only memory.

USB: universal serial bus.

“Computer-readable medium”, as used herein, refers to a medium that stores signals, instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, an optical medium (e.g., compact disc), a RAM, a ROM, a memory chip or card, a memory stick, and other media from which a computer, a processor or other electronic device can read.

“Data store”, as used herein, refers to a physical and/or logical entity that can store data. A data store may be, for example, a database, a table, a file, a list, a queue, a heap, a memory, a register, and so on. In different examples, a data store may reside in one logical and/or physical entity and/or may be distributed between two or more logical and/or physical entities.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

“Signal”, as used herein, includes but is not limited to, electrical signals, optical signals, analog signals, digital signals, data, computer instructions, processor instructions, messages, a bit, a bit stream, or other means that can be received, transmitted and/or detected.

“Software”, as used herein, includes but is not limited to, one or more executable instruction that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

“User”, as used herein, includes but is not limited to one or more persons, software, computers or other devices, or combinations of these.

A GUI component may comprise a GUI element that facilitates performing a task associated with a GUI. However, some GUI components may comprise multiple GUI elements. While systems and methods associated with GUI components containing a single GUI element are described, a person having ordinary skill in the art will understand from the disclosure how the present techniques may also be applicable to GUI components that contain groups of GUI elements. For example, a boilerplate website header may be a portion of a GUI for several web pages associated with different services performed by the same company. In some instances it may be appropriate to train a computer to treat the boilerplate header as a single GUI element even though it may be made up of multiple individual elements.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

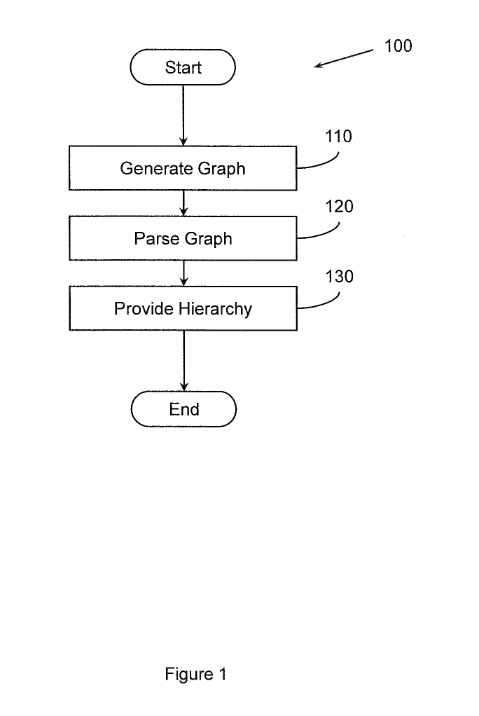

FIG. 1 illustrates an example embodiment of a method 100 associated with graphical user interface (GUI) hierarchy generation. Method 100 includes, at 110, generating a graph based on an image of a GUI instant. A GUI instant may be a state of a GUI between two consecutive inputs to a logic through the GUI. An input may be received from a mouse, a keyboard, and/or another input device. An input may also be inferred from a period of inactivity. A trigger that causes a change in the state of a GUI is an input. Thus, a GUI instant is a state of a GUI between two inputs. For example, consider a GUI in a first instant. A user may then select a menu button on top of the user interface using a mouse causing a menu of options to drop down. The GUI is now in a second instant. If the user were to let go of the mouse button, the GUI may enter a third instant. The third instant may be similar to the first instant if the user did not select an option from the menu.

However, a GUI instant may not all be visible in one screen image. For example, a user may have to scroll down a long webpage to access GUI components at the bottom of the webpage. In this case, the GUI components at the top of the webpage and the GUI components at the bottom of the webpage may be part of the same instant. This is consistent with the above, as scrolling down the web page is providing inputs to the web browser interface and not the webpage interface itself.

The graph generated based on the image of the GUI instant may contain nodes that represent GUI components depicted in the image. Edges in the graph may represent relationships between GUI components. In one example, relationships between GUI components may comprise spatial relationships between GUI components. In another example, generating the graph may also be based on a secondary source of information (e.g., a document object model (DOM)). Thus, relationships between GUI components may comprise spatial relationships and relationships between GUI components described in the secondary source of information. However, relationships between GUI components may be obtained using other techniques. Generating the graph may comprise segmenting the image of the GUI instant into images of GUI components. Generating the graph may also comprise identifying what types of GUI elements are contained in the images of GUI components.

Method 100 also includes, at 120, parsing the graph according to a formal graph grammar to produce a GUI hierarchy. The formal graph grammar may comprise a set of rules. A member of the set of rules may describe an action to take upon detecting a first pre-defined sub-graph in the graph. In one example, the action may comprise replacing the first pre-defined sub-graph in the graph with a second pre-defined sub-graph. The second pre-defined sub-graph may comprise a single node. The GUI hierarchy comprises descriptions of groups of GUI components from the image. A description of a group of GUI components may describe a function of the group of GUI components. Method 100 also includes, at 130, providing the GUI hierarchy. The GUI hierarchy may be provided to a data store, a content repurposing application, a help application, an object recognition application, an application monitoring system, an accessibility application, a search engine, and so on.

By way of illustration, an automated help application may be configured to provide additional information when the help application detects that a user is hovering a mouse cursor over elements of input forms. The automated help application may acquire an image of an input form from a computer's internal screen capture tool. The application may then segment the image into GUI components and identify what elements are contained in the segments. Based on relationships derived from image data, and/or data from an external source, the help application may generate a GUI hierarchy for the input form. The GUI hierarchy tells the help application how parts of the form are related, facilitating providing information to the user as they are working on the form.

While FIG. 1 illustrates various actions occurring in serial, it is to be appreciated that various actions illustrated in FIG. 1 could occur substantially in parallel. By way of illustration, a first process could generate a graph, a second process could parse the graph, and a third process could provide a GUI hierarchy. While three processes are described, it is to be appreciated that a greater and/or lesser number of processes could be employed and that lightweight processes, regular processes, threads, and other approaches could be employed.

In one example, a method may be implemented as computer executable instructions. Thus a computer-readable medium may store computer executable instructions that if executed by a machine (e.g., processor) cause the machine to perform a method. While executable instructions associated with the above method are described as being stored on a computer-readable medium, it is to be appreciated that executable instructions associated with other example methods described herein may also be stored on a computer-readable medium.

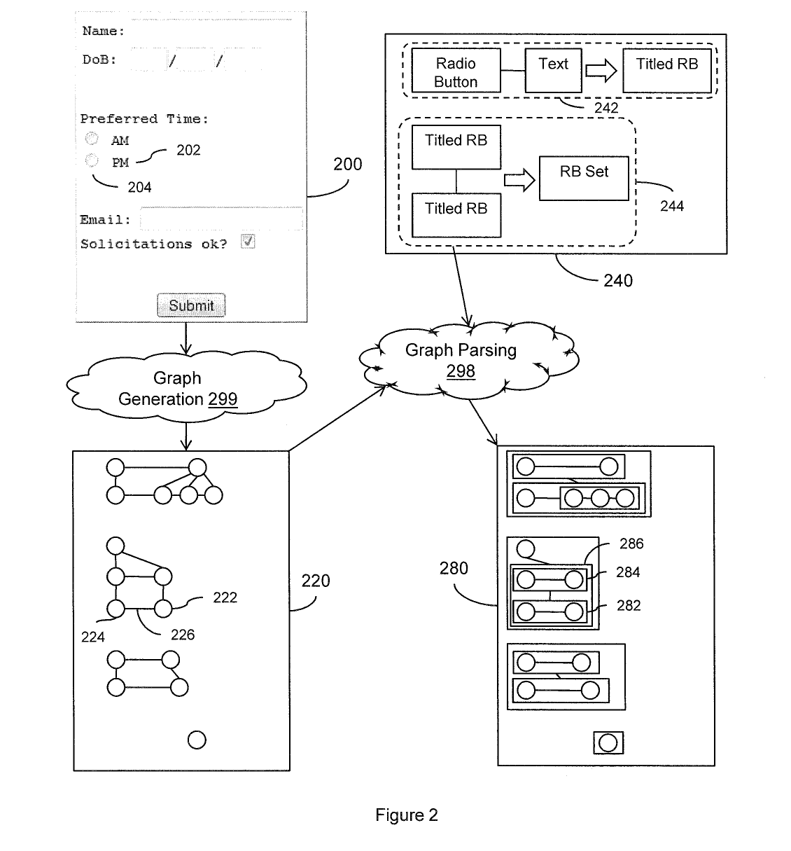

FIG. 2 illustrates example embodiments of data that are used and/or produced by example systems and methods. A person having ordinary skill in the art will recognize that some elements of FIG. 2 are visual representations of data structures that have several different functional implementations. FIG. 2 includes an image 200 of an example GUI. Image 200 illustrates several GUI components including a radio button 204, text 202, a submit button, input boxes, and so on. When graph generation 299 is performed using image 200 as an input, a graph similar to graph 220 may be generated. Generating a graph may comprise segmenting an image into images of GUI components. Generating a graph may also comprise identifying what types of GUI components are contained in the images of GUI components. Nodes representing the images of GUI components and edges representing relationships between GUI components may then be created to make a graph.

By way of illustration, in graph 220, text 202 is represented by node 222 and radio button 204 is represented by node 224. Edge 226 may represent the fact that the GUI component corresponding to node 222 (e.g., text 202) is to the left of, is close to, and/or horizontally aligned with the GUI component corresponding to node 224 (e.g., radio button 204). A person having ordinary skill in the art will recognize that there may be other nodes and/or edges that are not shown and that the portion of graph 220 that is shown represents one of many possible graphs that could be generated based on image 200.

FIG. 2 also includes an example graph grammar 240. Graph grammar 240 comprises rules describing how specific sub-graphs that may be found in a graph (e.g., graph 220) may be linked to facilitate generating a GUI hierarchy. A GUI hierarchy may represent how GUI components corresponding to nodes are related. For example, first rule 242 states that a radio button node connected with an edge that represents a relationship (e.g., close, horizontally aligned) to a text node should be considered a Titled RB. Second rule 244 states that a titled RB connected with an edge that represents a relationship (e.g., close, vertically aligned) to a second titled RB should be considered an RB set. When graph parsing 298 is performed using graph 220 and graph grammar 240 as inputs, a GUI hierarchy similar to GUI hierarchy 280 may be produced. By way of illustration, first rule 242 applied to node 222 and node 224 may cause a Titled RB 282 to be created in GUI hierarchy 280. Second rule 244 applied to Titled RB 282 and Titled RB 284 may cause a RB Set 286 to be created in GUI hierarchy 280.

In one example, rules in the graph grammar may describe an action to take in response to detecting a predefined sub-graph. For example, the action may include replacing the sub-graph with a single node in the graph, breaking certain edges relating to nodes in the sub-graph, and so on. The action may also be related to the construction of the GUI hierarchy. For example, the action may include adding nodes and/or edges to the hierarchy reflecting a relationship found in the sub-graph. However, the action may also be otherwise unrelated to the construction of the GUI hierarchy. For example, an accessibility application may perform text to speech functionality for a vision impaired person while they are working on an input form. In this example, the accessibility application may assign vocal output based on how nodes are related to surrounding text during hierarchy generation based on rules in the graph grammar.

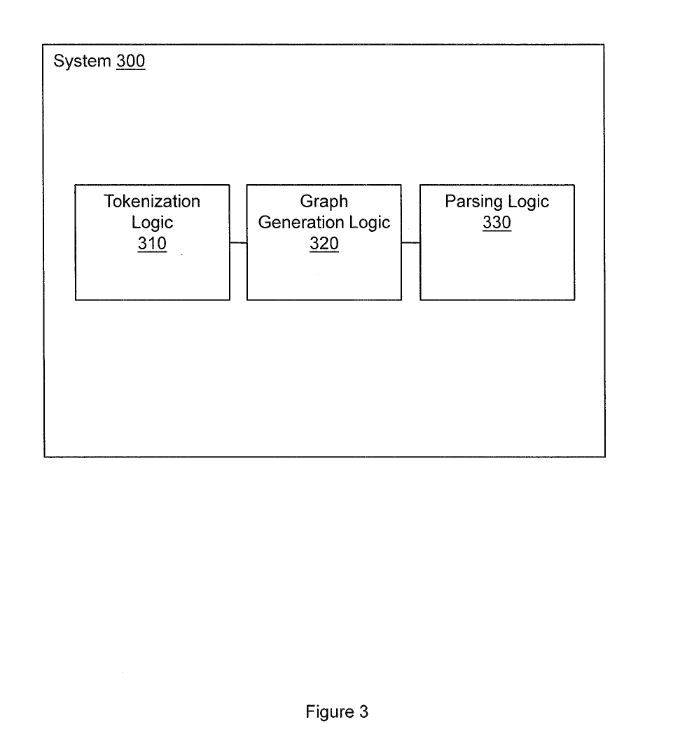

FIG. 3 illustrates an example embodiment of a system 300 associated with graphical user interface (GUI) hierarchy generation. System 300 includes a tokenization logic 310. Tokenization logic 310 may divide an image of a GUI into regions. A region may comprise an image of a GUI component. System 300 also includes a graph generation logic 320. Graph generation logic 320 may generate a graph based on the regions and on relationships between the regions. Nodes in the graph may represent regions of the GUI image. Edges in the graph may represent relationships between regions of the GUI image. Relationships between regions of the image may comprise spatial relationships between regions, relationships inferred from attributes of GUI components, relationships described in a secondary source of information (e.g., a DOM), and so on. System 300 also includes a parsing logic 330. Parsing logic 330 may generate a GUI hierarchy by parsing the graph according to a formal graph grammar. A GUI hierarchy may describe a hierarchical representation of the GUI.

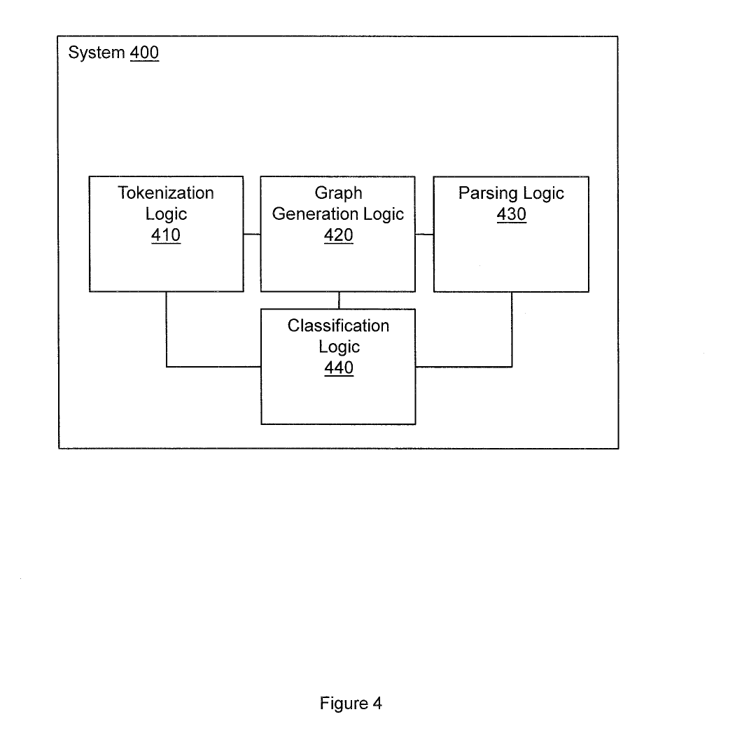

FIG. 4 illustrates an example embodiment of a system 400 associated with graphical user interface hierarchy generation. System 400 includes several elements similar to those described in relationship to system 300 (FIG. 3). For example, system 400 includes tokenization logic 410, graph generation logic 420, and a parsing logic 430. However, system 400 includes an additional element. System 400 includes classification logic 440. Classification logic 440 may assign labels to the nodes based on a region with which a node is associated. A label may describe what type of GUI element is contained in the region.

In one example, the formal graph grammar may describe an action to take upon detecting a predefined sub-graph in the graph. The predefined graph may be made up of nodes associated with specific labels. The nodes in the predefined graph may also be connected via specified edges. The action may include replacing the predefined sub-graph with a different sub-graph, reorganizing the graph, adding edges, removing edges, adding nodes, removing nodes, and so on. The action may also be otherwise unrelated to generating a GUI hierarchy. The action may include controlling a logic that initiated GUI hierarchy generation to perform an action. The action may also include attaching an instruction to a node(s) and/or edge(s) in the graph that cause a logic that initiated GUI hierarchy generation to perform an action. The action may also include modifying information associated with a node(s) and/or an edge(s). A person having ordinary skill in the art will recognize other actions that may be appropriate.

By way of illustration, it may be useful to include information in a GUI hierarchy generated for an application monitoring logic that tells the application monitoring logic what types of input to expect for various parts of a GUI. This may allow the application monitoring logic to determine if a user is attempting to input inappropriate data to the form. In another example, a GUI hierarchy provided to a search engine may be generated with information that tells the search engine what portions of the GUI contain relevant content that is worth indexing.

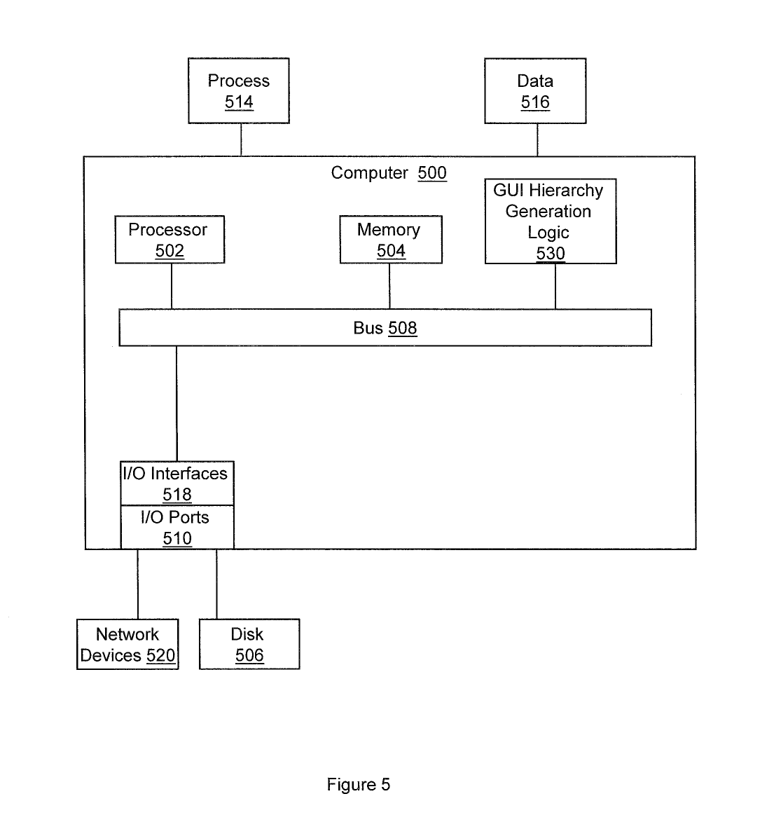

FIG. 5 illustrates an example embodiment of a computing device in which example systems and methods described herein, and equivalents, may operate. The example computing device may be a computer 500 that includes a processor 502, a memory 504, and input/output ports 510 connected by a bus 508. In one example, the computer 500 may include a graphical user interface (GUI) hierarchy generation logic 530. In different examples, the logic 530 may be implemented in hardware, software, firmware, and/or combinations thereof. While the logic 530 is illustrated as a hardware component attached to the bus 508, it is to be appreciated that in one example, GUI hierarchy generation logic 530 could be implemented in the processor 502.

GUI hierarchy generation logic 530 may provide means (e.g., hardware, software, firmware) for generating a graph based on an image of a graphical user interface (GUI). The graph comprises nodes representing components of the GUI and edges representing relationships between the components. The means may be implemented, for example, as an ASIC. The means may also be implemented as computer executable instructions that are presented to computer 500 as data 516 that are temporarily stored in memory 504 and then executed by processor 502. GUI hierarchy generation logic 530 may also provide means (e.g., hardware, software, firmware) for parsing the graph according to a formal graph grammar to generate a GUI hierarchy.

Generally describing an example configuration of the computer 500, the processor 502 may be a variety of various processors including dual microprocessor and other multi-processor architectures. A memory 504 may include volatile memory (e.g., ROM) and/or non-volatile memory (e.g., RAM).

A disk 506 may be connected to the computer 500 via, for example, an input/output interface (e.g., card, device) 518 and an input/output port 510. The disk 506 may be, for example, a magnetic disk drive, a solid state disk drive, a floppy disk drive, a tape drive, a Zip drive, a flash memory card, a memory stick, an optical disc, and so on. The memory 504 can store a process 514 and/or a data 516, for example. The disk 506 and/or the memory 504 can store an operating system that controls and allocates resources of the computer 500.

The bus 508 may be a single internal bus interconnect architecture and/or other bus or mesh architectures. While a single bus is illustrated, it is to be appreciated that the computer 500 may communicate with various devices, logics, and peripherals using other busses (e.g., PCIE, 1394, USB, Ethernet). The bus 508 can be types including, for example, a memory bus, a memory controller, a peripheral bus, an external bus, a crossbar switch, and/or a local bus.

The computer 500 may interact with input/output devices via the i/o interfaces 518 and the input/output ports 510. Input/output devices may be, for example, a keyboard, a microphone, a pointing and selection device, cameras, video cards, displays, the disk 506, the network devices 520, and so on. The input/output ports 510 may include, for example, serial ports, parallel ports, and USB ports.

The computer 500 can operate in a network environment and thus may be connected to the network devices 520 via the i/o interfaces 518, and/or the i/o ports 510. Through the network devices 520, the computer 500 may interact with a network. Through the network, the computer 500 may be logically connected to remote computers. Networks with which the computer 500 may interact include, but are not limited to, a local area network, a wide area network, and other networks.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

Some portions of the present disclosure are presented in terms of algorithms and symbolic representations of operations on data bits within a memory. These algorithmic descriptions and representations are used by those skilled in the art to convey the substance of their work to others. An algorithm, here and generally, is conceived to be a sequence of executable operations stored on a computer-readable medium that produce a result when executed.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A computer-readable medium storing computer-executable instructions that when executed by a computer cause the computer to perform a method, the method comprising:
generating a graph based on an image of a graphical user interface (GUI) instant, where nodes in the graph represent GUI components depicted in the image, and where edges in the graph represent relationships between GUI components depicted in the image; and
parsing the graph according to a formal graph grammar to produce a GUI hierarchy, where the GUI hierarchy comprises descriptions of groups of GUI components from the image; and
providing the GUI hierarchy.

2. The computer-readable medium of claim 1, where a GUI instant is a state of a GUI between two consecutive inputs to a logic associated with the GUI.

3. The computer-readable medium of claim 1, where generating the graph comprises segmenting the image of the GUI instant into images of GUI components.

4. The computer-readable medium of claim 3, where generating the graph comprises identifying GUI elements contained in the images of GUI components.

5. The computer-readable medium of claim 1, where the GUI hierarchy is provided to one or more of a data store, a content repurposing application, a help application, an object recognition application, an application monitoring system, an accessibility application, and a search engine.

6. The computer-readable medium of claim 1, where the formal graph grammar comprises a set of rules, where a member of the set of rules describes an action to take upon detecting a first pre-defined sub-graph in the graph.

7. The computer-readable medium of claim 6, where parsing the graph comprises detecting a pre-defined sub-graph in the graph and performing an action associated with the pre-defined sub-graph.

8. The computer-readable medium of claim 6, where the action comprises replacing the first pre-defined sub-graph in the graph with a second pre-defined sub-graph.

9. The computer-readable medium of claim 8, where the second pre-defined sub-graph comprises a single node.

10. The computer-readable medium of claim 1, where a description of a group of GUI components describes a function of the group of GUI components.

11. The computer-readable medium of claim 1, where the relationships between GUI components comprise spatial relationships between GUI components.

12. The computer-readable medium of claim 1, where generating the graph is also based on a secondary source of information

13. The computer-readable medium of claim 12, where the relationships between GUI components comprise one or more of spatial relationships between GUI components and relationships between GUI components obtained from the secondary source of information.

14. A system, comprising:
tokenization logic to divide an image of a graphical user interface (GUI) into regions, where a region comprises an image of a GUI component;
graph generation logic to generate a graph based on the regions and on relationships between the regions; and
parsing logic to generate a GUI hierarchy by parsing the graph according to a formal graph grammar, where the GUI hierarchy describes a hierarchical representation of the GUI.

15. The system of claim 14, where the nodes in the graph represent regions of the GUI image.

16. The system of claim 15, where the edges in the graph represent relationships between regions of the GUI image.

17. The system of claim 16, where relationships between regions of the image comprise spatial relationships between regions, relationships inferred from attributes of GUI components, and relationships described in a secondary source of information.

18. The system of claim 16, comprising a classification logic to assign labels to the nodes based on a region with which a node is associated, where a label describes what type of GUI component is contained in the region.

19. The system of claim 18, where the formal graph grammar describes an action to take upon detecting a predefined sub-graph in the graph, where the predefined sub-graph is made up of nodes associated with specified labels, and where the nodes are connected via specified edges.

20. A system, comprising:
means for generating a graph based on an image of a graphical user interface (GUI), where the graph comprises nodes representing components of the GUI and edges representing relationships between the components; and
means for parsing the graph according to a formal graph grammar to generate a GUI hierarchy.
